(19) United States
(12) Patent Application Publication
(10) Pub. No.: US 2018/0053351 A1
(43) Pub. Date: Feb. 22, 2018

(54) AUGMENTED REALITY EXPERIENCE ENHANCEMENT METHOD AND APPARATUS

(71) Applicant: Intel Corporation, Santa Clara, CA (US)

(72) Inventor: Glen J. Anderson, Beaverton, OR (US)

(21) Appl. No.: 15/242,300

(22) Filed: Aug. 19, 2016

(51) Int. Cl. G06T 19/00; G06K 9/00; G06F 3/01

(52) U.S. Cl. CPC G06T 19/006; G06F 3/011; G06K 9/00671

(57) ABSTRACT

Apparatus and method to facilitate augmented reality (AR) experience are disclosed herein. One or more modules to be executed by one or more processors to provide a particular AR content element within an AR experience in progress for a user, in view of a particular real world event, may be provided. Wherein to provide includes to monitor status of the particular predictable real world event from among a plurality of predictable real world events, wherein the particular predictable real world event is relevant to the AR experience in progress for the user; adjust the AR experience in progress in preparation of occurrence of the particular predictable real world event in association to the user; and provide the particular AR content element, from among the plurality of AR content elements, within the AR experience in progress, in response to eminent occurrence of the particular predictable real world event.

### TECHNICAL FIELD

The present disclosure relates generally to the technical field of computing, and more particularly, to computing systems for facilitating augmented reality experiences.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

Unlike virtual reality, which may replace the real world with a simulated or virtual world, augmented reality (AR) may comprise augmenting or supplementing a real world environment with one or more computer-generated sensory content. With simultaneous consumption of the real world and AR content by a person, if there is dissonance between the real world content and the AR content, there is diminution of the AR experience by the person. For example, the person may be consuming an AR experience comprising a story while commuting to work. As real world events associated with the commute occur, such as running to catch an elevator, such events may not fit the AR storyline or interrupt consumption of the AR story. It would be beneficial to align AR content to real world events so as to improve the AR experience.

### BRIEF DESCRIPTION OF THE DRAWINGS

Embodiments will be readily understood by the following detailed description in conjunction with the accompanying drawings. The concepts described herein are illustrated by way of example and not by way of limitation in the accompanying figures. For simplicity and clarity of illustration, elements illustrated in the figures are not necessarily drawn to scale. Where considered appropriate, like reference labels designate corresponding or analogous elements.

FIG. 1 depicts a block diagram illustrating a network view of an example system for practicing the present disclosure, according to some embodiments.

FIG. 2 depicts an example logical view of the system of FIG. 1, illustrating algorithmic structures included in system and data associated with the processes performed by the algorithmic structures, according to some embodiments.

FIG. 3 depicts an example process to automatically monitor one or more predictable events and incorporate such predictable events into the AR experience in progress, according to some embodiments.

FIG. 4 depicts example images of occurrence of a predictable event and use of the occurrence in the AR experience in progress, according to some embodiments.

FIG. 5 depicts an example computing environment suitable for practicing various aspects of the present disclosure, according to some embodiments.

FIG. 6 depicts an example non-transitory computer-readable storage medium having instructions configure to practice all or selected ones of the operations associated with the processes described in reference to FIGS. 1-4.

### DETAILED DESCRIPTION

Computing apparatuses, methods and storage media for incorporating real world events into augmented reality (AR) experiences are described herein. In some embodiments, an apparatus may include one or more processors; and one or more modules to be executed by the one or more processors to provide a particular AR content element within an AR experience in progress for a user, in view of a particular real world event. Wherein to provide, the one or more modules are to: monitor status of the particular predictable real world event from among a plurality of predictable real world events, wherein the particular predictable real world event is relevant to the AR experience in progress for the user; adjust the AR experience in progress in preparation of occurrence of the particular predictable real world event in association to the user; and provide the particular AR content element, from among the plurality of AR content elements, within the AR experience in progress, in response to eminent occurrence of the particular predictable real world event, wherein the particular AR content element is in context relative to the AR experience in progress and to the particular real world event. These and other aspects of the present disclosure will be more fully described below.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). As used herein, the term “logic” and “module” may refer to, be part of, or include an application specific integrated circuit (ASIC), an electronic circuit, a processor (shared, dedicated, or group), and/or memory (shared, dedicated, or group) that execute one or more software or firmware programs having machine instructions (generated from an assembler and/or a compiler), a combinational logic circuit, and/or other suitable components that provide the described functionality.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

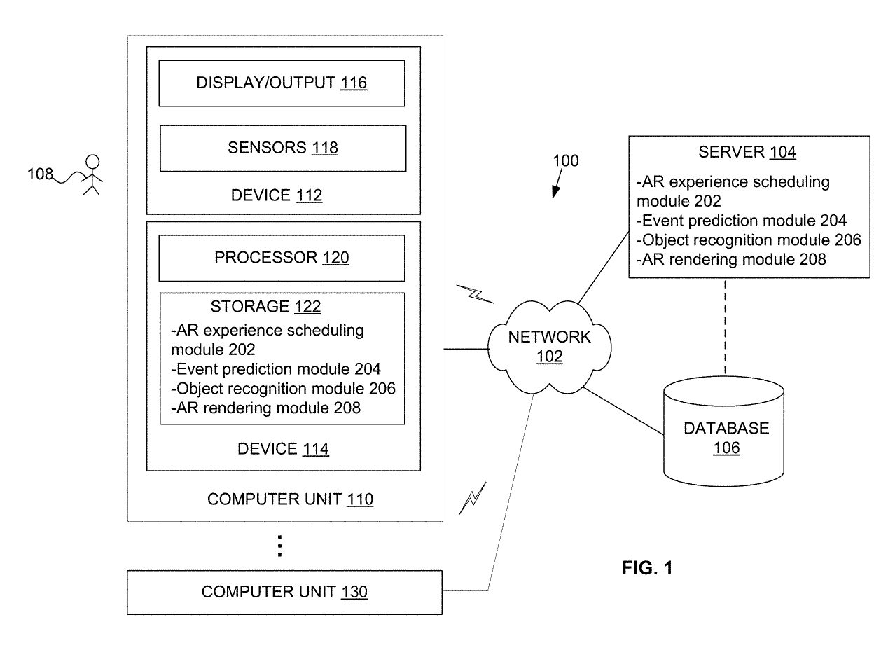

FIG. 1 depicts a block diagram illustrating a network view of an example system 100 for practicing the present disclosure, according to some embodiments. System 100 may include a network 102, a server 104, a database 106, a computer unit 110, and a computer unit 130. Each of the server 104, database 106, and computer units 110, 130 may communicate with the network 102.

Network 102 may comprise one or more wired and/or wireless communications networks. Network 102 may include one or more network elements (not shown) to physically and/or logically connect computer devices to exchange data with each other. In some embodiments, network 102 may be the Internet, a wide area network (WAN), a personal area network (PAN), a local area network (LAN), a campus area network (CAN), a metropolitan area network (MAN), a virtual local area network (VLAN), a cellular network, a WiFi network, a WiMax network, and/or the like. Additionally, in some embodiments, network 102 may be a private, public, and/or secure network, which may be used by a single entity (e.g., a business, school, government agency, household, person, and the like). Although not shown, network 102 may include, without limitation, servers, databases, switches, routers, gateways, firewalls, base stations, repeaters, software, firmware, intermediating servers, and/or other components to facilitate communication.

In some embodiments, server 104 may comprise one or more computers, processors, or servers having one or more modules with machine instructions configured to perform event prediction and augmented reality (AR) experience adjustment techniques described herein. The machine instructions may be generated from an assembler or compiled from a high level language compiler. As described earlier, server 104 may communicate with database 106 (directly or indirectly via network 102), computer unit 110, and/or computer unit 130, via network 102. Server 104 may host one or more applications accessed by a computer unit (e.g., computer unit 110) or component of the computer unit and/or execute one or more computer readable instructions to facilitate operation of the computer unit or a component thereof. In some embodiments, server 104 may include one or more of an AR experience scheduling module 202, an event prediction module 204, an object recognition module 206, and/or an AR rendering module 208. Server 104 may provide processing functionalities for the computer unit; provide data to and/or receive data from the computer unit; predict events that may be relevant to running AR experiences; automatically adjust one or more running AR experiences in accordance in predictable events; and the like, to be described in greater detail below. In some embodiments, server 104 may include one or more web servers, one or more application servers, one or more servers providing user interface (UI) or graphical user interface (GUI) functionalities, and the like.

Database 106 may comprise one or more storage devices to store data and/or instructions for use by computer unit 110, computer unit 130, and/or server 104. The content of database 106 may be accessed via network 102 and/or directly by the server 104. The content of database 106 may be arranged in a structured format to facilitate selective retrieval. In some embodiments, the content of database 106 may include, without limitation, AR stories, AR games, AR experience content, AR content, AR elements, real to virtual mapping profiles, predictable events, and the like. In some embodiments, database 106 may comprise more than one database. In some embodiments, database 106 may be included within server 104.

Computer unit 110 may comprise one or more wired and/or wireless communication computing devices in communication with server 104 via network 102. Computer unit 110 may be configured to facilitate generation of and/or provide an AR experience to a user 108 and further to adjust the AR experience in real-time (or near real-time) in accordance with the state of predicted/predictable/scheduled real world events. Computer unit 110 may comprise, without limitation, one or more head gears, eye gears, augmented reality units, work stations, personal computers, general purpose computers, laptops, Internet appliances, hand-held devices, wireless devices, Internet of Things (IoT) devices, wearable devices, set top boxes, appliances, wired devices, portable or mobile devices, cellular or mobile phones, portable digital assistants (PDAs), smart phones, tablets, multi-processor systems, microprocessor-based or programmable consumer electronics, game consoles, network PCs, mini-computers, and the like.

In some embodiments, computer unit 110 may comprise a single unit or more than one unit. For example, computer unit 110 may comprise a single unit, such as AR head or eye gear, to be worn by (or in proximity to) the user 108. As a single unit, computer unit 110 may include a display/output 116, sensors 118, processor 120, storage 122, and the like. As another example, computer unit 110 may comprise more than one unit, such as a device 112 and a device 114. In some embodiments, device 112 may comprise an AR device to be worn by (or in proximity to) the user 108, and configured to at least provide or display AR content to the user 108; while device 114 may comprise a device to generate and/or otherwise facilitate providing AR content to be displayed to the device 112. Device 112 may include the display/output 116 and sensors 118; and device 114 may include the processor 120 and storage 120. Device 112 may comprise, for example, head or eye gear; and device 114 may comprise, for example, a smartphone or tablet in communication with the device 112. Device 114 may include one or more modules with machine instructions configured to perform event prediction and augmented reality (AR) experience adjustment techniques described herein. In some embodiments, computer unit 110, or device 114 of computer unit 110, may include one or more of the AR experience scheduling module 202, event prediction module 204, object recognition module 206, and/or AR rendering module 208.

In some embodiments, display/output 116 may comprise a projector and transparent surface onto which the AR content provided by the projector may be presented. For instance, eye or head gear may include a transparent lens onto which the AR content may be projected onto and through which the user 108 may simultaneously view the real world as well as the AR content. Alternatively, display/output 116 may comprise a transparent display or screen in which the AR content may be presented and through which the user 108 may view the real world. As another alternative, display/output 116 may include visual, audio, olfactory, tactile, and/or other sensory output mechanisms. For instance, in addition to visual output mechanisms (e.g., projector, display, etc.), display/output 116 may also include speakers to provide audio AR content.

Sensors 118 may comprise one or more sensors, detectors, or other mechanisms to obtain information about the real world environment associated with the user 108. Sensors 118 may include, without limitation, cameras (e.g., two-dimensional (2D), three-dimensional (3D), depth, infrared, etc.), microphones, touch sensors, proximity sensors, accelerometers, gyroscopes, location sensors, global positioning satellite (GPS) sensors, and the like.

In some embodiments, processor 120 may comprise one or more processors, central processing units (CPUs), video cards, motherboards, and the like configured to perform processing of sensor data, rendering of AR content, tracking predicted events, adjusting the AR experience in response to the tracked predicted events, and the like, as discussed in detail below. In some embodiments, processor 120 may execute instructions associated with one or more of the AR experience scheduling module 202, event prediction module 204, object recognition module 206, and/or AR rendering module 208. Storage 120 may comprise one or more memories to store data associated with practicing aspects of the present disclosure including, but not limited to, AR stories, AR games, AR content, AR elements, predicted events, real to virtual profiles associated with AR content, and the like.

Although not shown, computer unit 110 may also include, without limitation, circuitry, communication sub-systems (e.g., Bluetooth, WiFi, cellular), user interface mechanisms (e.g., buttons, keyboard), and the like. In alternative embodiments, one or more components of computer unit 110 may be optional if, for example, one or more functionalities may be performed by the server 104 and/or database 106. For example, if all of the data associated with practicing aspects of the present disclosure may be stored in database 106 and/or processing functions may be performed by server 104, then storage 122 may be a small amount of memory sufficient for buffering data but not large enough to store a library of AR stories, for instance. Similarly, processor 120 may be configured for minimal processing functionalities but need not be powerful enough to render AR content, for instance.

Computer unit 130 may be similar to computer unit 110. Although two computer units are shown in FIG. 1, it is understood that more than two computer units may be implemented in system 100. Although a single server 104 and database 106 are shown in FIG. 1, each of server 104 and database 106 may comprise two or more components and/or may be located at one or more geographically distributed location from each other. Alternatively, database 106 may be included within server 104. Furthermore, while system 100 shown in FIG. 1 employs a client-server architecture, embodiments of the present disclosure are not limited to such an architecture, and may equally well find application in, for example, a distributed or peer-to-peer architecture system.

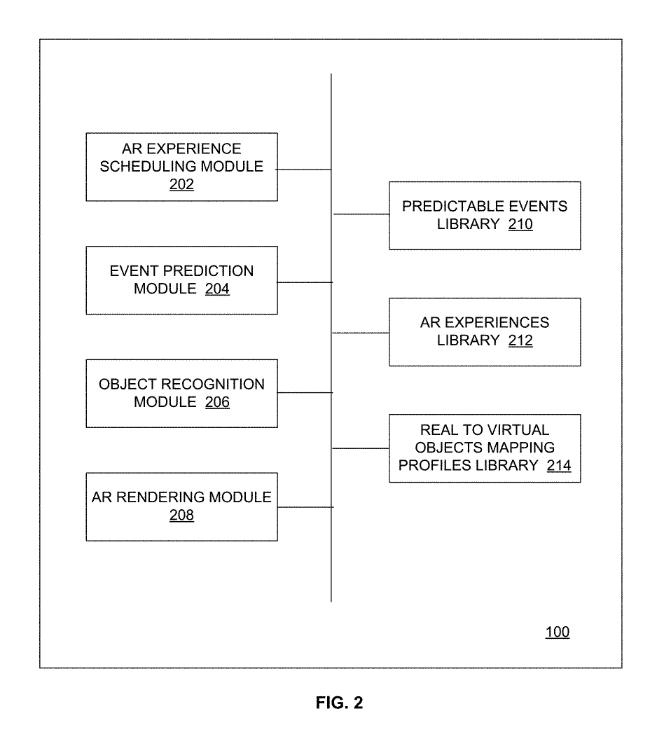

FIG. 2 depicts an example logical view of the system 100, illustrating algorithmic structures included in system 100 and data associated with the processes performed by the algorithmic structures, according to some embodiments. The various components and/or data shown in FIG. 2 may be implemented at least partially by hardware at one or more computing devices, such as one or more hardware processors executing instructions stored in one or more memories for performing various functions described herein. The components and/or data may be communicatively coupled (e.g., via appropriate interfaces) to each other and to various data sources, so as to allow information to be passed between the components and/or to share and access common data. FIG. 2 illustrates only one of many possible arrangements of components and data configured to perform the functionalities described herein. Other arrangements may include fewer or different components and/or data, and the division of work between the components and/or data may vary depending on the arrangement. In some embodiments, modules 202-208 may comprise one or more software components, programs, applications, or other units of code base or instructions configured to be executed by one or more processors included in the server 102 and/or computer unit 110. Although modules 202-208 may be depicted as distinct components in FIG. 2, modules 202-208 may be implemented as fewer or more components than illustrated.

In some embodiments, the AR experience scheduling module 202 may be configured to determine and control potential adjustment(s) to presentation of the current AR experience in accordance with tracked predictable event(s) by the event prediction module 204. As discussed in detail below, the AR experience scheduling module 202 may anticipate the occurrence of one or more predictable events associated with the real world, and may initiate preparation of adjustment to the AR experience in progress so that one or more of the predictable events, upon actual occurrence in the real world, may be incorporated into and/or be used to enhance the AR experience in progress. AR experiences may comprise, without limitation, AR stories, AR games, AR interactions, AR storylines, arrangements of AR content or elements, AR narratives, or other presentation of AR content or elements (e.g., characters, icons, narratives, scenery, dialogue, sounds, tactile elements, olfactory elements, etc.). A plurality of AR experiences may be provided in an AR experiences library 210, which may be stored in the database 106 and/or storage 122.

The event prediction module 204 may be configured to track or monitor the progress of the one or more predictable events, in some embodiments. The event prediction module 204 may also be configured to select particular ones of the predictable event(s) from among a plurality of predictable events in accordance with factors such as, but not limited to, the particular AR experience in progress, the particular portion of the AR experience in progress, user preferences, user profile information learned over time, and the like. Particular ones of the predictable events may be tracked to determine when the respective events may occur in the real world. The event prediction module 204 may select particular ones of the predictable events to track from information associated with a plurality of predictable events provided in a predictable events library 210, which may be stored in the database 106 and/or storage 122.

The predictable events library 210 (also referred to as a predicted events library, scheduled events library, or anticipated events library) may comprise information associated with each of a plurality of predictable events. Each predictable events of the plurality of predictable events may comprise a real world event that may be known to be scheduled, anticipated, or predictable. Examples of predictable events include, but are not limited to:
Buses, trains, ferries, or other public transport arrival times at certain locations
Airplane traffic
Sunset and sunrise times
Thunder, lightning, hailstorms, or other weather event arrival times
Projected trajectory of a drive, walk, or other modes of travel and what objects may be anticipated to appear within the projected trajectory
Garbage collection times and associated sounds
Mail routes and associated sounds
Projected sounds at known times (e.g., scheduled fire drill in a particular building, school bells for class begin and end times, etc.).

In some embodiments, some information associated with a particular predictable event may be obtained by the event prediction module 204 in real-time or near real-time. For example, in order to anticipate the actual arrival time of a particular bus at a particular bus stop, event prediction module 204 may access real-time bus travel data from the bus provider's website.

The object recognition module 206 may be configured to detect and recognize occurrence of real world events in proximity to and/or relevant to the AR experience in progress for the user 108 based on information provided by the sensors 118. In some embodiments, the event prediction module 204 may track particular predictable events earlier in time than the object recognition module 206. Such predictable events may be handled by the event prediction module 204 during a time period in which the sensors 118 may not be able to detect anything associated with a particular predictable event because the particular predictable event may be out of range of the sensors 118. When the particular predictable event may be within range of the sensors 118, the particular predictable event may be “handed over” to the object recognition module 206 from the event prediction module 204, in some embodiments, because the particular predictable event may now be actually occurring. Continuing the above example of tracking a bus arrival, when the sensors 118 are able to detect the bus arriving at the particular bus stop (e.g., a camera “sees” the bus arriving at the particular bus stop), object recognition module 206 may process the sensor information to recognize the bus and to recognize that the bus is arriving at the particular bus stop at the current point in time.

Once a tracked predictable event is imminent and/or occurring, the AR rendering module 208 may integrate the tracked predictable event into the AR experience in progress. Continuing the above example of the arriving bus, the AR rendering module 208 may access a particular vehicle profile included in the real to virtual objects mapping profiles library 214, which may be stored in the database 106 and/or storage 122. The particular vehicle profile accessed may comprise information about a vehicle (visual, audio, and/or tactile information) that fits or better fits the AR experience in progress rather than the bus arriving in the real world. Such accessed information may be used to render a representation of the particular vehicle within the AR experience in progress, to be superimposed over the bus arriving in the real world environment. The bus may be replaced with a rendering of a space ship, for example, and thus the user 108 may board a space ship rather than a bus, which may better fit with the AR story being consumed by the user 108 at the time of boarding the bus in the real world.

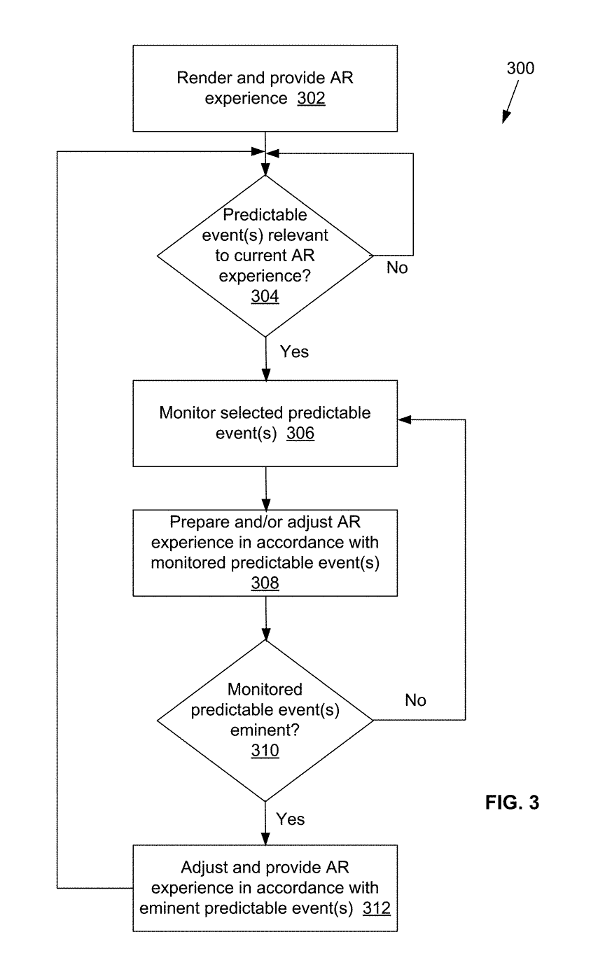

FIG. 3 depicts an example process 300 to automatically monitor one or more predictable events and incorporate such predictable events into the AR experience in progress, according to some embodiments.

At block 302, the AR rendering module 208 may initiate, render, and provide a particular AR experience to the computer unit 110 (or device 112). In some embodiments, a particular AR experience, such as a particular AR story, may be selected by the user 108 from among a plurality of AR experiences, or the AR rendering module 208 may automatically select the particular AR experience based on random selection, user profile, user preferences, or the like. While the particular AR experience is in progress, playing, or running, blocks 304-312 may be performed.

At block 304, the event prediction module 204 in conjunction with the AR experience scheduling module 202 may determine which ones of the plurality of predictable events (also referred to as scheduled events, anticipated events, predicted events, or the like) may be relevant to the currently playing AR experience. In some embodiments, the predictable events library 210 may include association or relevancy information between particular ones of the plurality of predictable events to respective ones of the plurality of AR experiences; characteristics of each of the plurality of predictable events which may be matched to those of respective ones of the plurality of AR experiences; and the like. In other embodiments, each one of the plurality of AR experiences may specify which predictable events may be relevant at particular time points, scenes, branches, or other portions of the AR experiences. In still other embodiments, select ones of the plurality of predictable events may be deemed relevant based on a profile associated with the user 108; user preferences; user selections; user's routine; user's current location and time of day; machine learning of the user's preferences, routine, etc.; and/or other considerations.

If there is no predictable event relevant or pertinent to the portion of the current AR experience currently in progress (no branch of block 304), then process 300 may proceed to continue monitoring for relevant predictable events as the AR experience continues to execute, in block 304. If there is at least one predictable event that may be deemed relevant to the portion of the current AR experience currently in progress (yes branch of block 304), then process 300 may proceed to block 306.

At block 306, the event prediction module 204 may monitor or track the predictable event(s) selected or deemed to be relevant in block 304. In some embodiments, the event prediction module 204 may access third party information sources in order to determine the current state or status of one or more of the relevant predictable event(s) and/or the scheduling or occurrence information associated with one or more of the relevant predictable event(s) may be included in the predictable events library 210. Examples of third party information sources may include, without limitation, websites (e.g., bus service provider website, airline schedules, weather forecast services, maps), GPS satellites, information subscription services, text messages, messaging apps, and the like.

For example, if the relevant predictable event comprises a bus arriving at a bus stop that the user 108 may be waiting, the event prediction module 204 may access the bus service provider's website that provides real-time or near real-time status of whether the bus is on time or not or estimated arrival time at particular bus stops. As another example, if the relevant predictable event comprises a sunrise for today, the sunrise times for every day of the year may be accessed from the predictable events library 210 or a website of the sunrise time schedule. As another example, a moving vehicle associated with a relevant predictable event may have a GPS receiver that allows its position to be tracked, which allows the system 100 to increase prediction accuracy of the vehicle's arrival time. As still another example, a second user associated with a relevant predictable event may indicate his or her arrival time via a text message, which the event prediction module 204 may use via natural language processing.

Next at block 308, the AR experience scheduling module 202 may prepare and/or adjust the AR experience in progress in accordance with the predictable event(s) being monitored in block 306. The AR experience scheduling module 202 may start making adjustments to the presentation of the AR experience prior to occurrence of monitored predictable event(s), as necessary, in order for the portion of the AR experience that is to occur at the same time as a particular predictable event to be logically consistent or in context with the particular predictable event, when it occurs in the real world, and/or be enhanced by the particular predictable event occurring in the real world.

Adjustments and/or preparations may include, without limitation, changing the pace of the AR experience (e.g., slowing down or speeding up the current scene of the AR experience); transitioning to a new scene or branch of the AR experience that will fit with the soon-to-occur predictable event; switching to a different AR experience (e.g., a different AR story); adding one or more audio, haptic, vibrations, or the like AR elements associated with the relevant predictable event to the AR experience in progress in preparation of the actual occurrence of the relevant predictable event; cause virtual character(s) in the AR experience to react to the predicted arrival of a predicted real world object (e.g., virtual characters clearing virtual tracks for the arrival of a virtual train, which may be a bus in reality); and the like. In some embodiments, the AR experience scheduling module 202 may coordinate an AR experience in progress across a plurality of users, thus making adjustments simultaneously or sequentially in accordance with each user's location relative to the same predictable event.

For example, if the user 108 is waiting at a bus stop for a scheduled bus to arrive, the AR experience scheduling module 202 may “unfold” the AR experience to coincide with the approximate arrival time of the bus. When the AR experience includes a storyline, for example, about a space ship arrival, the AR experience scheduling module 202 may align the occurrence of the space ship arrival portion of the AR experience with the real world arrival of the user's bus. Thus, the bus arrival may not be an ad hoc element of reality that may disrupt or interrupt the user's immersion in the AR storyline. Instead, a real world event—the bus arrival—may be used to enhance the AR experience. For instance, the storyline may include a narrative of a character waiting for and boarding a space ship. Starting a couple of minutes prior to the anticipated arrival of the bus, the AR experience scheduling module 202 may start the portion of the AR storyline where a character waits for and boards a space ship. Thus, the arrival of the AR space ship may coincide with arrival of the bus in the real world, and the AR rendering module 208 may render or superimpose a space ship over where the user 108 may otherwise view the bus arriving. The AR storyline may even include the user 108 as the character entering the AR space ship when the user 108 boards the bus in the real world. In this manner, real world event(s) may be used as “triggers” that influence the particular execution of an AR experience, both prior to and during occurrence of the real world event(s). And at least during occurrence of the real world event(s), such real world event(s) may be weaved into the AR experience, which may enhance the immersive quality and/or realism of the AR experience to the user.

Next at block 310, the object recognition module 206 may determine whether actual (or real world) occurrence of the predictable event(s) being monitored in block 306 may be eminent. In some embodiments, object recognition module 206 may use information provided by the sensors 118 to detect objects in and/or the state of the real world and real time (or near real time) environment proximate to the user 108. Such detections may then be used to recognize or identify which predictable event may be occurring and a (more) exact time of when the predictable event may occur (as opposed to the estimated or scheduled time associated with the predictable event). Continuing the example of the bus arrival, sensors 118 (such as one or more cameras) may detect the presence of an object in the user 108's line of vision. The object recognition module 206 may implement object recognition techniques to determine that the object is the bus for which its arrival is being anticipated. Among other things, object recognition techniques may take into account the corners of the detected object, the overall shape of the detected object, the perspective of the detected object in the user 108's line or vision, markings on the detected object, and the like to determine that the object may be the bus of interest.

If none of the predictable event(s) being monitored may be eminent (no branch of block 310), then process 300 may proceed to continue monitoring the selected ones of the predictable events in block 306. Otherwise at least one of the predictable events being monitored may be about to occur (yes branch of block 310), and process 300 may proceed to block 312.

At block 312, the AR rendering module 208, in conjunction with the object recognition module 206, may perform final adjustments, as necessary, render, and provide the AR experience taking into account the eminent predictable event(s). The AR rendering module 208 may, in some embodiments, access the real to virtual objects mapping profiles library 214 to obtain one or more profiles associated with the object(s) to be projected/displayed in accordance with the eminent predictable event(s). The real to virtual objects mapping profiles library 214 may comprise a plurality of profiles associated with respective ones of a plurality of AR objects (also referred to as AR content, AR elements, AR items, or AR content elements). The plurality of objects may comprise visual, audio, haptic, tactile, olfactory, and/or other sensory receptive objects that may be sensed by the user 108. Each profile of the plurality of profiles may include the requisite data to render, present, or provide a respective object within the AR experience, taking into account factors such as different scaling, perspective, presentation level, duration, intensity, and the like.

In some embodiments, the particular way in which the eminent predictable event(s) may be sensed (or is being sensed) by the user 108 may be taken into account in how the associated AR object(s) may be presented to the user 108. Knowing when a predictable event is about to occur in the real world may permit the AR experience to be enhanced, adjusted, tailored, or otherwise take into account the real world event as it occurs in the AR world. Thus, the timing and occurrence of one or more real world events may be seamless and not disruptive to the AR experience, and at the same time, such real world events may facilitate a more immersive AR experience because real world events, as they occur in real time, may become part of the storyline.

In some embodiments, one or more AR object(s) or elements may be superimposed over or replace the object(s) associated with the predictable event(s), and/or one or more AR object(s) may be provided in addition to the object(s) associated with the predictable event(s). In the bus arrival example, the particular size, orientation, and/or lighting conditions in which the bus may be viewed by the user 108 (e.g., perspective view, front view, partially shaded, etc.) may be duplicated in presenting the corresponding AR object(s) superimposed over or replacing the bus. To perform such functions, markers and/or characteristics of the bus detected by the sensors 118 and/or recognized by the object recognition module 206 may be used in rendering the AR object(s) associated with the eminent predictable event(s).

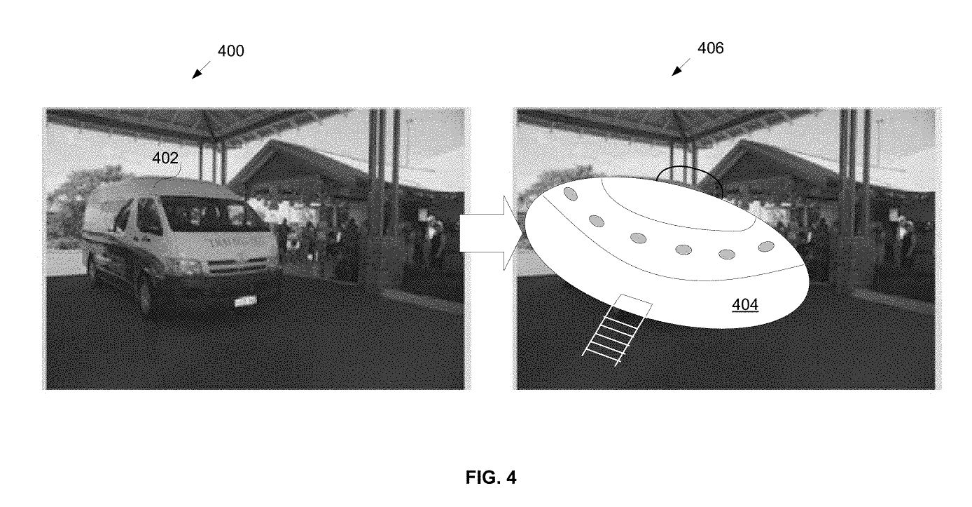

FIG. 4 depicts example images of occurrence of a predictable event and use of the occurrence in the AR experience in progress, according to some embodiments. An image 400 on the left illustrates the real world environment that may be viewed by the user 108. The left image 400 shows the occurrence of a predictable event, namely, arrival of a bus 402. With implementation of the process 300 in FIG. 3, the AR rendering module 208 may augment or supplement the real world environment shown in image 400 with one or more AR objects or elements, namely, superimposition of the bus 402 with a space ship 404, as shown in an image 406 on the right. Accordingly, the user 108 may see the space ship 404 instead of the bus 402, as shown in image 406, during the time that the bus 402 may be at the bus stop and in proximity to the user 108. The bus arrival allows the system 100 to make the occurrence of a real world event work more seamlessly and immersively with the AR experience or storyline in progress.

In some embodiments, particular predictable events may trigger a particular AR experience response. The table below provides example predictable events and corresponding presentation of AR content when the predictable event occurs.

| Predictable events | AR content response |
|---|---|
| Bus or train arrival | Replace visual/audio/vibration of bus or train |
| | arrival with a vehicle from the current AR |
| | experience |
| Airplane traffic | Replace visual/audio/vibration of airplane |
| | traffic with a vehicle from the current AR |
| | experience |
| Sunset or sunrise | Trigger event(s) in the current AR experience |
| | causing lighting changes consistent with |
| | occurrence of sunset or sunrise |
| Thunderstorm arrival | Relevant in AR experiences including storms |
| | (e.g., talking about storms), and may include |
| | AR sounds such as thunder |
| Projected trajectory of a | AR experience may provide one or more AR |
| drive, walk, or other | objects or elements to supplement or replace |
| mode of travel with | one or more anticipated objects/buildings/etc. |
| anticipated objects/ | along the projected trajectory |
| buildings/etc. along | |
| the projected trajectory | |
| Certain sounds | AR elements may at least partially magnify, |
| | supplement, suppress, or cancel out the real |
| | world sounds |

Once the AR element(s) in response to the eminent predictable event(s) have been provided, process 300 may return to block 304 to determine and monitor additional or new predictable event(s) that may be relevant to the now current AR experience.

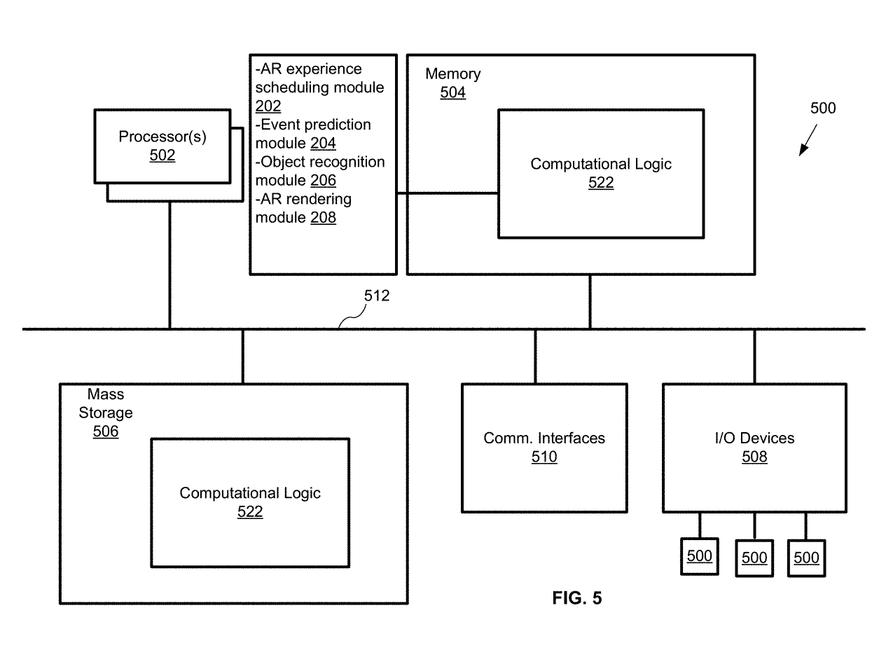

FIG. 5 illustrates an example computer device 500 suitable for use to practice aspects of the present disclosure, in accordance with various embodiments. In some embodiments, computer device 500 may comprise any of the server 104, database 104, computer unit 110, and/or computer unit 130. As shown, computer device 500 may include one or more processors 502, and system memory 504. The processor 502 may include any type of processors. The processor 502 may be implemented as an integrated circuit having a single core or multi-cores, e.g., a multi-core microprocessor. The computer device 500 may include mass storage devices 506 (such as diskette, hard drive, volatile memory (e.g., DRAM), compact disc read only memory (CD-ROM), digital versatile disk (DVD), flash memory, solid state memory, and so forth). In general, system memory 504 and/or mass storage devices 506 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computer device 500 may further include input/output (I/O) devices 508 (such as a display 502), keyboard, cursor control, remote control, gaming controller, image capture device, and so forth and communication interfaces 510 (such as network interface cards, modems, infrared receivers, radio receivers (e.g., Bluetooth)), and so forth.

The communication interfaces 510 may include communication chips (not shown) that may be configured to operate the device 500 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 510 may operate in accordance with other wireless protocols in other embodiments.

The above-described computer device 500 elements may be coupled to each other via a system bus 512, which may represent one or more buses. In the case of multiple buses, they may be bridged by one or more bus bridges (not shown). Each of these elements may perform its conventional functions known in the art. In particular, system memory 504 and mass storage devices 506 may be employed to store a working copy and a permanent copy of the programming instructions implementing the operations associated with system 100, e.g., operations associated with providing the AR experience scheduling module 202, event prediction module 204, object recognition module 206, and/or AR rendering module 208, generally shown as computational logic 522. Computational logic 522 may be implemented by assembler instructions supported by processor(s) 502 or high-level languages that may be compiled into such instructions. The permanent copy of the programming instructions may be placed into mass storage devices 506 in the factory, or in the field, through, for example, a distribution medium (not shown), such as a compact disc (CD), or through communication interfaces 510 (from a distribution server (not shown)).

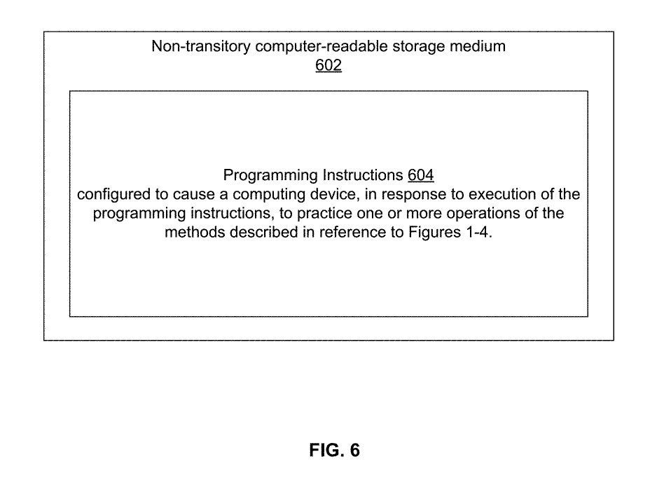

FIG. 6 illustrates an example non-transitory computer-readable storage media 602 having instructions configured to practice all or selected ones of the operations associated with the processes described above. As illustrated, non-transitory computer-readable storage medium 602 may include a number of programming instructions 604 (e.g., AR experience scheduling module 202, event prediction module 204, object recognition module 206, and/or AR rendering module 208). Programming instructions 604 may be configured to enable a device, e.g., computer device 500, in response to execution of the programming instructions, to perform one or more operations of the processes described in reference to FIGS. 1-4. In alternate embodiments, programming instructions 604 may be disposed on multiple non-transitory computer-readable storage media 602 instead. In still other embodiments, programming instructions 804 may be encoded in transitory computer-readable signals.

Referring again to FIG. 5, the number, capability, and/or capacity of the elements 508, 510, 512 may vary, depending on whether computer device 500 is used as a stationary computing device, such as a set-top box or desktop computer, or a mobile computing device, such as a tablet computing device, laptop computer, game console, an Internet of Things (IoT), or smartphone. Their constitutions are otherwise known, and accordingly will not be further described.

At least one of processors 502 may be packaged together with memory having computational logic 522 configured to practice aspects of embodiments described in reference to FIGS. 1-4. For example, computational logic 522 may be configured to include or access AR experience scheduling module 202, event prediction module 204, object recognition module 206, and/or AR rendering module 208. In some embodiments, at least one of the processors 502 may be packaged together with memory having computational logic 522 configured to practice aspects of process 300 to form a System in Package (SiP) or a System on Chip (SoC).

In various implementations, the computer device 500 may comprise a laptop, a netbook, a notebook, an ultrabook, a smartphone, a tablet, an Internet of Things (IoT) device, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computer device 500 may be any other electronic device that processes data.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein.

Examples of the devices, systems, and/or methods of various embodiments are provided below. An embodiment of the devices, systems, and/or methods may include any one or more, and any combination of, the examples described below.

Example 1 is an apparatus including one or more processors; and one or more modules to be executed by the one or more processors to provide a particular augmented reality (AR) content element within an AR experience in progress for a user, in view of a particular real world event, wherein to provide, the one or more modules are to: monitor status of the particular predictable real world event from among a plurality of predictable real world events, wherein the particular predictable real world event is relevant to the AR experience in progress for the user, adjust the AR experience in progress in preparation of occurrence of the particular predictable real world event in association to the user, and provide the particular AR content element, from among the plurality of AR content elements, within the AR experience in progress, in response to eminent occurrence of the particular predictable real world event, wherein the particular AR content element is in context relative to the AR experience in progress and to the particular real world event.

Example 2 may include the subject matter of Example 1, and may further include wherein to provide the particular AR content element, the one or more modules are to superimpose a real world item associated with the particular predictable real world event with the particular AR content element within the AR experience in progress.

Example 3 may include the subject matter of any of Examples 1-2, and may further include wherein to provide the particular AR content element, the one or more modules are to at least partly suppress a real world item associated with the particular predictable real world event with the particular AR content element within the AR experience in progress.

Example 4 may include the subject matter of any of Examples 1-3, and may further include wherein a real world item associated with the particular predictable real world event comprises a visual, an audio, a hepatic, a tactile, or an olfactory associated item.

Example 5 may include the subject matter of any of Examples 1-4, and may further include wherein the one or more modules are to further detect the eminent occurrence of the particular predictable real world event when the real world item is in proximity to the user.

Example 6 may include the subject matter of any of Examples 1-5, and may further include wherein the AR experience in progress comprises an AR story, an AR game, an AR interaction, an AR storyline, an arrangement of AR content elements, an AR narrative, or a presentation of AR content elements.

Example 7 may include the subject matter of any of Examples 1-6, and may further include wherein to monitor status of the particular predictable real world event, the one or more modules are to obtain the status from one or more third party information sources, and wherein the status comprises at least an estimated time of occurrence of the particular predictable real world event in proximity to the user.

Example 8 may include the subject matter of any of Examples 1-7, and may further include wherein to adjust the AR experience in progress in preparation of the occurrence of the particular predictable real world event, the one or more modules are to change a pace of the AR experience in progress for the provision of the particular AR content element within the AR experience to coincide with occurrence of the particular predictable real world event.

Example 9 may include the subject matter of any of Examples 1-8, and may further include wherein to adjust the AR experience in progress in preparation of the occurrence of the particular predictable real world event, the second module is to transition or switch to a particular portion of a storyline associated with the AR experience, wherein the particular portion is in context with and to coincide with occurrence of the particular predictable real world event.

Example 10 is a computerized method including monitoring status of a particular predictable real world event from among a plurality of predictable real world events, wherein the particular predictable real world event is relevant to an augmented reality (AR) experience in progress for a user; adjusting the AR experience in progress in preparation of occurrence of the particular predictable real world event in association to the user; and providing the particular AR content element, from among a plurality of AR content elements, within the AR experience in progress, in response to eminent occurrence of the particular predictable real world event, wherein the particular AR content element is in context relative to the AR experience in progress and to the particular real world event.

Example 11 may include the subject matter of Example 10, and may further include wherein providing the particular AR content element comprises superimposing a real world item associated with the particular predictable real world event with the particular AR content element within the AR experience in progress.

Example 12 may include the subject matter of any of Examples 10-11, and may further include wherein providing the particular AR content element comprises at least partly suppressing a real world item associated with the particular predictable real world event with the particular AR content element within the AR experience in progress.

Example 13 may include the subject matter of any of Examples 10-12, and may further include wherein a real world item associated with the particular predictable real world event comprises a visual, an audio, a hepatic, a tactile, or an olfactory associated item.

Example 14 may include the subject matter of any of Examples 10-13, and may further include detecting the eminent occurrence of the particular predictable real world event when the real world item is in proximity to the user.

Example 15 may include the subject matter of any of Examples 10-14, and may further include wherein the AR experience in progress comprises an AR story, an AR game, an AR interaction, an AR storyline, an arrangement of AR content elements, an AR narrative, or a presentation of AR content elements.

Example 16 may include the subject matter of any of Examples 10-15, and may further include wherein monitoring the status of the particular predictable real world event comprises obtaining the status from one or more third party information sources, and wherein the status comprises at least an estimated time of occurrence of the particular predictable real world event in proximity to the user.

Example 17 may include the subject matter of any of Examples 10-16, and may further include wherein adjusting the AR experience in progress in preparation of the occurrence of the particular predictable real world event comprises changing a pace of the AR experience in progress for the provision of the particular AR content element within the AR experience to coincide with occurrence of the particular predictable real world event.

Example 18 may include the subject matter of any of Examples 10-17, and may further include wherein adjusting the AR experience in progress in preparation of the occurrence of the particular predictable real world event comprises transitioning or switching to a particular portion of a storyline associated with the AR experience, wherein the particular portion is in context with and to coincide with occurrence of the particular predictable real world event.

Example 19 is an apparatus including means for monitoring status of a particular predictable real world event from among a plurality of predictable real world events, wherein the particular predictable real world event is relevant to an augmented reality (AR) experience in progress for a user; means for adjusting the AR experience in progress in preparation of occurrence of the particular predictable real world event in association to the user; and means for providing the particular AR content element, from among a plurality of AR content elements, within the AR experience in progress, in response to eminent occurrence of the particular predictable real world event, wherein the particular AR content element is in context relative to the AR experience in progress and to the particular real world event.

Example 20 may include the subject matter of Example 19, and may further include wherein the means for providing the particular AR content element comprises means for superimposing a real world item associated with the particular predictable real world event with the particular AR content element within the AR experience in progress.

Example 21 may include the subject matter of any of Examples 19-20, and may further include wherein the means for providing the particular AR content element comprises means for at least partly suppressing a real world item associated with the particular predictable real world event with the particular AR content element within the AR experience in progress.

Example 22 may include the subject matter of any of Examples 19-21, and may further include means for detecting the eminent occurrence of the particular predictable real world event when the real world item is in proximity to the user.

Example 23 may include the subject matter of any of Examples 19-22, and may further include wherein the means for monitoring the status of the particular predictable real world event comprises means for obtaining the status from one or more third party information sources, and wherein the status comprises at least an estimated time of occurrence of the particular predictable real world event in proximity to the user.

Example 24 is one or more computer-readable storage medium comprising a plurality of instructions to cause an apparatus, in response to execution by one or more processors of the apparatus, to: monitor status of a particular predictable real world event from among a plurality of predictable real world events, wherein the particular predictable real world event is relevant to an augmented reality (AR) experience in progress for a user; adjust the AR experience in progress in preparation of occurrence of the particular predictable real world event in association to the user; and provide the particular AR content element, from among a plurality of AR content elements, within the AR experience in progress, in response to eminent occurrence of the particular predictable real world event, wherein the particular AR content element is in context relative to the AR experience in progress and to the particular real world event.

Example 25 may include the subject matter of Example 24, and may further include wherein to provide the particular AR content element comprises to superimpose a real world item associated with the particular predictable real world event with the particular AR content element within the AR experience in progress.

Example 26 may include the subject matter of any of Examples 24-25, and may further include wherein to provide the particular AR content element comprises to at least partly suppress a real world item associated with the particular predictable real world event with the particular AR content element within the AR experience in progress.

Example 27 may include the subject matter of any of Examples 24-26, and may further include wherein a real world item associated with the particular predictable real world event comprises a visual, an audio, a hepatic, a tactile, or an olfactory associated item.

Example 28 may include the subject matter of any of Examples 24-27, and may further include wherein the plurality of instructions, in response to execution by the one or more processors of the apparatus, further cause to detect the eminent occurrence of the particular predictable real world event when the real world item is in proximity to the user.

Example 29 may include the subject matter of any of Examples 24-28, and may further include wherein the AR experience in progress comprises an AR story, an AR game, an AR interaction, an AR storyline, an arrangement of AR content elements, an AR narrative, or a presentation of AR content elements.

Example 30 may include the subject matter of any of Examples 24-29, and may further include wherein to monitor the status of the particular predictable real world event comprises to obtain the status from one or more third party information sources, and wherein the status comprises at least an estimated time of occurrence of the particular predictable real world event in proximity to the user.

Example 31 may include the subject matter of any of Examples 24-30, and may further include wherein to adjust the AR experience in progress in preparation of the occurrence of the particular predictable real world event comprises to change a pace of the AR experience in progress for the provision of the particular AR content element within the AR experience to coincide with occurrence of the particular predictable real world event.

Example 32 may include the subject matter of any of Examples 24-31, and may further include wherein to adjust the AR experience in progress in preparation of the occurrence of the particular predictable real world event comprises to transition or switch to a particular portion of a storyline associated with the AR experience, wherein the particular portion is in context with and to coincide with occurrence of the particular predictable real world event.

Computer-readable media (including non-transitory computer-readable media), methods, apparatuses, systems, and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure.

This application is intended to cover any adaptations or variations of the embodiments discussed herein. Therefore, it is manifestly intended that embodiments described herein be limited only by the claims.

1. An apparatus comprising:
one or more processors; and
one or more modules to be executed by the one or more processors to provide a particular augmented reality (AR) content element within an AR experience in progress for a user, in view of a particular predictable real world event, wherein to provide, the one or more modules are to:
monitor status of the particular predictable real world event from among a plurality of predictable real world events, wherein the particular predictable real world event is relevant to the AR experience in progress for the user,
adjust the AR experience in progress in preparation of occurrence of the particular predictable real world event in association to the user, and
provide the particular AR content element, from among the plurality of AR content elements, within the AR experience in progress, in response to eminent occurrence of the particular predictable real world event, wherein the particular AR content element is in context relative to the AR experience in progress and to the particular real world event.

2. The apparatus of claim 1, wherein to provide the particular AR content element, the one or more modules are to superimpose a real world item associated with the particular predictable real world event with the particular AR content element within the AR experience in progress.

3. The apparatus of claim 1, wherein to provide the particular AR content element, the one or more modules are to at least partly suppress a real world item associated with the particular predictable real world event with the particular AR content element within the AR experience in progress.

4. The apparatus of claim 1, wherein the one or more modules are to further detect the eminent occurrence of the particular predictable real world event when the real world item is in proximity to the user.

5. The apparatus of claim 1, wherein to adjust the AR experience in progress in preparation of the occurrence of the particular predictable real world event, the one or more modules are to change a pace of the AR experience in progress for the provision of the particular AR content element within the AR experience to coincide with occurrence of the particular predictable real world event.

6. The apparatus of claim 1, wherein to adjust the AR experience in progress in preparation of the occurrence of the particular predictable real world event, the one or more modules are to transition or switch to a particular portion of a storyline associated with the AR experience, wherein the particular portion is in context with and to coincide with occurrence of the particular predictable real world event.

7. A computerized method comprising:
monitoring status of a particular predictable real world event from among a plurality of predictable real world events, wherein the particular predictable real world event is relevant to an augmented reality (AR) experience in progress for a user;
adjusting the AR experience in progress in preparation of occurrence of the particular predictable real world event in association to the user; and
providing the particular AR content element, from among a plurality of AR content elements, within the AR experience in progress, in response to eminent occurrence of the particular predictable real world event, wherein the particular AR content element is in context relative to the AR experience in progress and to the particular real world event.

8. The method of claim 7, wherein a real world item associated with the particular predictable real world event comprises a visual, an audio, a hepatic, a tactile, or an olfactory associated item.

9. The method of claim 8, further comprising detecting the eminent occurrence of the particular predictable real world event when the real world item is in proximity to the user.

10. The method of claim 7, wherein the AR experience in progress comprises an AR story, an AR game, an AR interaction, an AR storyline, an arrangement of AR content elements, an AR narrative, or a presentation of AR content elements.

11. The method of claim 7, wherein monitoring the status of the particular predictable real world event comprises obtaining the status from one or more third party information sources, and wherein the status comprises at least an estimated time of occurrence of the particular predictable real world event in proximity to the user.

12. An apparatus comprising:
means for monitoring status of a particular predictable real world event from among a plurality of predictable real world events, wherein the particular predictable real world event is relevant to an augmented reality (AR) experience in progress for a user;
means for adjusting the AR experience in progress in preparation of occurrence of the particular predictable real world event in association to the user; and
means for providing the particular AR content element, from among a plurality of AR content elements, within the AR experience in progress, in response to eminent occurrence of the particular predictable real world event, wherein the particular AR content element is in context relative to the AR experience in progress and to the particular real world event.

13. The apparatus of claim 12, wherein the means for providing the particular AR content element comprises means for superimposing a real world item associated with the particular predictable real world event with the particular AR content element within the AR experience in progress.

14. The apparatus of claim 12, wherein the means for monitoring the status of the particular predictable real world event comprises means for obtaining the status from one or more third party information sources, and wherein the status comprises at least an estimated time of occurrence of the particular predictable real world event in proximity to the user.

15. One or more non-transitory computer-readable storage medium comprising a plurality of instructions to cause an apparatus, in response to execution by one or more processors of the apparatus, to:
monitor status of a particular predictable real world event from among a plurality of predictable real world events, wherein the particular predictable real world event is relevant to an augmented reality (AR) experience in progress for a user;
adjust the AR experience in progress in preparation of occurrence of the particular predictable real world event in association to the user; and
provide the particular AR content element, from among a plurality of AR content elements, within the AR experience in progress, in response to eminent occurrence of the particular predictable real world event, wherein the particular AR content element is in context relative to the AR experience in progress and to the particular real world event.

16. The non-transitory computer-readable storage medium of claim 15, wherein to provide the particular AR content element comprises to superimpose a real world item associated with the particular predictable real world event with the particular AR content element within the AR experience in progress.

17. The non-transitory computer-readable storage medium of claim 15, wherein a real world item associated with the particular predictable real world event comprises a visual, an audio, a hepatic, a tactile, or an olfactory associated item.

18. The non-transitory computer-readable storage medium of claim 17, wherein the plurality of instructions, in response to execution by the one or more processors of the apparatus, further cause to detect the eminent occurrence of the particular predictable real world event when the real world item is in proximity to the user.

19. The non-transitory computer-readable storage medium of claim 15, wherein to monitor the status of the particular predictable real world event comprises to obtain the status from one or more third party information sources, and wherein the status comprises at least an estimated time of occurrence of the particular predictable real world event in proximity to the user.

20. The non-transitory computer-readable storage medium of claim 15, wherein to adjust the AR experience in progress in preparation of the occurrence of the particular predictable real world event comprises to transition or switch to a particular portion of a storyline associated with the AR experience, wherein the particular portion is in context with and to coincide with occurrence of the particular predictable real world event.
